(19) United States
(12) Patent Application Publication
(10) Pub. No.: US 2024/0028504 A1
(43) Pub. Date: Jan. 25, 2024

(54) METHOD AND DEVICE FOR EVALUATING QUALITY OF DIGITAL HUMAN

(71) Applicant: Electronics and Telecommunications Research Institute, Daejeon (KR)

(72) Inventors: Seung Wook LEE, Daejeon (KR); Ki Nam KIM, Daejeon (KR); Tae Joon KIM, Sejong-si (KR); Seung Uk YOON, Daejeon (KR); Bon Woo HWANG, Daejeon (KR)

(73) Assignee: Electronics and Telecommunications Research Institute, Daejeon (KR)

(21) Appl. No.: 18/350,842

(22) Filed: Jul. 12, 2023

(30) Foreign Application Priority Data
Jul. 22, 2022 (KR) 10-2022-0091123
Mar. 10, 2023 (KR) 10-2023-0031821

(51) Int. Cl. G06F 11/36; G06N 3/008

(52) U.S. Cl. CPC G06F 11/3692; G06N 3/008

(57) ABSTRACT

An apparatus for evaluating the quality of digital human content included in a source input are disclosed. The apparatus comprises a test method generation unit configured to receive test methods including identification information of questions and evaluation methods for the questions, and referring to a pre-stored question list and an evaluation method set, generate at least one of subjective test methods or objective test methods from the test methods. The apparatus comprises an evaluation result acquisition unit configured to obtain subjective evaluation results for the digital human content using the subjective test methods and obtain objective evaluation results for the digital human content using the objective test methods. The apparatus comprises a quality evaluation unit configured to output a final evaluation result for the digital human content based on the subjective evaluation results and the objective evaluation results

### CROSS REFERENCE TO RELATED APPLICATION

The present application is based on and claims the benefit of priority to Korean Patent Application Number 10-2022-0091123, filed on Jul. 22, 2022, and Korean Patent Application Number 10-2023-0031821, filed on Mar. 10, 2023 in the Korean Intellectual Property Office, the entire disclosure of which is incorporated herein by reference.

### TECHNICAL FIELD

The present disclosure relates to a method and a device for evaluating quality of digital human.

### BACKGROUND

The statements in this section merely provide background information related to the present disclosure and may not constitute prior art.

With the spread of metaverse services in recent years, the demand for digital human content is continuously increasing due to high-quality 3D models in game services that were previously provided, remote medical care due to the COVID-19 situation, and human body simulations for pharmaceutical research.

A digital human is a simulation of a person implemented on a computer, which is visually rendered in a human-like form and includes artificial intelligence (AI) components to interpret a user's input and respond in a contextually appropriate manner. The digital human can interact with individuals using verbal and/or non-verbal cues. By implementing natural language processing (NLP), chatbots, and/or other software, the digital human can be configured to provide human-like interactions with users or to perform activities such as scheduling, starting, stopping, and monitoring the operations of various devices.

The digital humans are being increasingly used in various fields. As a result, there is a growing demand for verifying and standardizing the quality of digital humans.

The quality of digital humans is quantified by the sense of realism that people feel when they interact with digital humans without feeling alienated. Technically, the geometric precision and the speed of 3D modeling can be examples of quantitative performance quality factors for digital humans, but it is difficult to objectify the quantitative quality of digital

Most important aspect of this digital human?” when people look at a digital human is a complex problem. Depending on individual and cultural differences, the answer could be the face, eyes, mouth, or movement. Furthermore, it is not easy to systematically objectify digital humans.

Accordingly, there is a need for a method for evaluating the quality of digital humans.

### SUMMARY

According to at least one embodiment, the present disclosure provides an apparatus for evaluating the quality of digital human content included in a source input are disclosed. The apparatus comprises a test method generation unit configured to receive test methods including identification information of questions and evaluation methods for the questions, and referring to a pre-stored question list and an evaluation method set, generate at least one of subjective test methods or objective test methods from the test methods. The apparatus comprises an evaluation result acquisition unit configured to obtain subjective evaluation results for the digital human content using the subjective test methods and obtain objective evaluation results for the digital human content using the objective test methods. The apparatus comprises a quality evaluation unit configured to output a final evaluation result for the digital human content based on the subjective evaluation results and the objective evaluation results.

According to another embodiment of the present disclosure, a computer-implemented method for evaluating the quality of digital human content included in a source input is provided. The method comprises receiving test methods including identification information of questions and evaluation methods for the questions. The method further comprises referring to a pre-stored question list and an evaluation method set, generating at least one of subjective test methods or objective test methods from the test methods. The method further comprises obtaining subjective evaluation results for the digital human content using the subjective test methods. The method further comprises obtaining objective evaluation results for the digital human content using the objective test methods. The method further comprises outputting a final evaluation result for the digital human content based on the subjective evaluation results and the objective evaluation results.

### BRIEF DESCRIPTION OF THE DRAWINGS

FIG. 1 is a block diagram of a quality evaluation system for a digital human according to an embodiment of the present disclosure.

FIG. 2 is a diagram illustrating a test case input according to an embodiment of the present disclosure.

FIG. 3 is a diagram illustrating a test case output according to an embodiment of the present disclosure.

FIG. 4 is a flowchart of a method for evaluating the quality of a digital human according to an embodiment of the present disclosure.

### DETAILED DESCRIPTION

The present disclosure provides an apparatus and method for evaluating the quality of a digital human through systematization of a quality evaluation method consisting of a combination of a question list and an evaluation method.

Further, the present disclosure provides a quality evaluation device and method for providing an objective and accurate evaluation of the quality of a digital human rather than a uniform evaluation.

The problems to be solved by the present disclosure are not limited to those mentioned above, and other problems not mentioned will be clearly understood by those skilled in the art from the description below.

Embodiments of the present disclosure are described below in detail using various drawings. It should be noted that when reference numerals are assigned to components in each drawing, the same components have the same reference numerals as much as possible, even if they are displayed on different drawings. Furthermore, in the description of the present disclosure, where it has been determined that a specific description of a related known configuration or function may obscure the gist of the disclosure, a detailed description thereof has been omitted.

In describing the components of the embodiments according to the present disclosure, symbols such as first, second, i), ii), a), and b) may be used. These symbols are only used to distinguish components from other components. The identity or sequence or order of the components is not limited by the symbols. In the specification, when a part “includes” or is “equipped with” an element, this means that the part may further include other elements, not excluding other elements unless explicitly stated to the contrary. Further, when an element in the written description and claims is described as being “for” performing or carry out a stated function, step, set of instructions, or the like, the element may also be considered as being “configured to” do so.

Each component of a device or method according to the present disclosure may be implemented in hardware or software, or in a combination of hardware and software. In addition, the functions of each component may be implemented in software. A microprocessor or processor may execute functions of the software corresponding to each component.

P3097.3 of the IEEE Standards Association provides a Standard Framework for Evaluating Quality of Digital Humans. Embodiments of the present disclosure may be supported by standard documents related to systems for evaluating the quality of digital humans of the IEEE. In particular, the embodiments of the present disclosure may be supported by the standard document IEEE 3079.3.

To evaluate the quality of digital human content, objective evaluation methods as well as subjective evaluation methods are required. The quality of digital human content is related to human factors for immersive content services, which define a measure for evaluating the realism of digital human content. Here, the realism refers to the feeling of a real object or the sense of feeling that there is no difference from the real object. For the evaluation of digital human content, a framework must be defined that involves processing the digital human content as test data, defining test methods and test cases, and providing an evaluation report on the test results.

A quality evaluation device for the quality of digital human content according to an embodiment of the present disclosure generates a digital human service using a subjective evaluation method and an objective evaluation method and evaluates the quality of content provided by a service provider. The quality evaluation device may determine the quality of digital human content through a subjective evaluation method and an objective evaluation method, and in particular, may determine the quality of digital human content using a combination of several methods, thereby efficiently and accurately determining the quality.

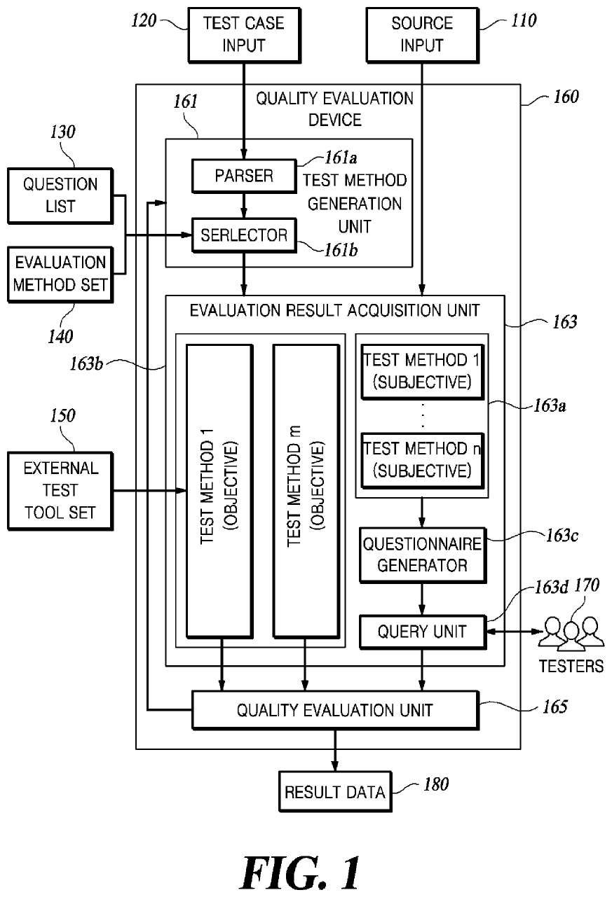

FIG. 1 is a block diagram of a quality evaluation system for a digital human according to an embodiment of the present disclosure.

Referring to FIG. 1, a source input 110, a test case input (TC input) 120, a question list (QL) 130, an evaluation method set 140, an external test tool set 150, a quality evaluation device 160, testers 170, and result data 180 are shown.

The quality evaluation device 160 includes a test method generation unit 161, an evaluation result acquisition unit 163, and a quality evaluation unit 165. The quality evaluation device 160 selects subjective test methods and objective test methods from a predefined test case input 120 using the question list 130 and the evaluation method set 140, performs a subjective evaluation and an objective evaluation for the source input 110 using the testers 170 and the external test tool set 150, and outputs the result data 180 for the evaluation.

The source input 110 is image or video data containing digital human content. The source input 110 is a quality evaluation target of the quality evaluation device 160. For example, the source input 110 may be image or video data of digital human content generated by 3D modeling of a person's face, head, upper body, lower body, etc. The source input 110 is received from a service provider. Here, the service provider is a company that creates and provides digital human-related services and contents.

A test case includes a test case input 120 and a test case output. The test case input 120 includes information for the quality evaluation device 160 to evaluate the quality of the source input 110. The test case output includes the result data 180 for the test case input 120 together with the test case input 120 and may further include test environment information.

The test case input 120 is a predefined quality evaluation file package for evaluating the quality of the digital human content in the source input 110. The test case input 120 defines a single test that is executed to achieve a specific test goal for the quality of the digital human content in the source input 110. Specifically, the test case input 120 includes information of test methods that query the realism of the source input 110. The test case input 120 may be created by a test designer. Here, the test designer is a person who manages the entire digital human quality test by designing the test cases using a series of combinations of questions and evaluation methods in the question list 130 and the evaluation method set 140. Here, the question is a query defined for an evaluation test based on quality factors. The evaluation method is a tool for evaluating the quality of digital human content. A combination of one question in the question list and one evaluation method results in a test method. The test case input 120 may be generated according to the JavaScript Object Notation (JSON) format.

The test case input 120 includes at least one of a test case ID (TestCaseID), the number of test methods (numOfTestMethods), a test method instance (TestMethodInstance), a weight, or a test method (TestMethod). The above-mentioned components represent semantic key values of the test case input 120. The test case ID represents the unique number of the test case input 120, the number of test methods represents the total number of questions in the test case input 120, and the test method instance represents the test methods of the test case input 120. The weight is a value applied to evaluation scores of the test methods to adjust the importance of the evaluation scores of the test methods. The test method instance may include the test methods and the weight of each test method.

Each test method included in the test case input 120 includes identification information of a question, and an evaluation method for the question. One test method may include one question item and one evaluation method. The evaluation methods are divided into subjective evaluation methods and objective evaluation methods. The subjective evaluation method includes identification information and a response format, and the objective evaluation method includes identification information and test tool set information. The identification information of the question is identification information indicating any one of a plurality of questions in the question list 130. The identification information of the evaluation method is information indicating any one of a plurality of evaluation methods in the evaluation method set 140. The identification information of the evaluation method is a criterion for distinguishing whether the evaluation method is a subjective evaluation method or an objective evaluation method. The response format of the evaluation method refers to how the testers 170 respond to the evaluation method. The response format of the evaluation method can be set in various ways according to the identification information of the evaluation method. A tester is a person who performs a subjective test to evaluate the quality of digital human content.

The test methods included in the test case input 120 are divided into subjective test methods 163a and objective test methods 163b based on the question list 130 and the evaluation method set 140 by the test method generation unit 161. Here, the question list 130 and the evaluation method set 140 are information stored in a separate repository.

The question list 130 is a set of questions defined by quality factors based on the characteristics of the digital human and based on the social presence. The question list 130 includes identification information of various questions and question items. The question items of the question list 130 may be grouped into various categories based on the quality factors of the digital human. For example, the categories of the question items may include shape, interaction, cognitive social presence, emotional social presence, whole human, and user defined question. Here, the social presence refers to the feeling of being with other people, influenced by digital interfaces in human-computer interaction. The cognitive social presence refers to the concept of the degree to which the presence of a digital human engaging in communication is felt locally. The emotional social presence refers to the emotional bond that emerges during a social interaction with a digital human in content (e.g., AR/VR, metaverse environments). The user-defined question refers to a questions specified by the test designer to apply a specific requirement to the test.

Table 1 shows an example of the question list 130:

TABLE 1

| Category | | ID | Questions | Ref |
|---|---|---|---|---|
| Shape | Face | QL_SPE_0001 | Is the face natural? | |
| | Micro- | QL_SPE_0002 | Is the micro-geometry natural? | |
| | geometry | | | |
| | Texture map | QL_SPE_0003 | Is the texture map natural? | |
| | Eye | QL_SPE_0004 | Are the eyes natural? | |
| | Mouth | QL_SPE_0005 | Is the mouth natural? | |
| | Hair | QL_SPE_0006 | Is the hair natural? | |
| | Body | QL_SPE_0007 | Is the body natural? | |
| Interaction | Motion | QL_ITR_0001 | Is the motion natural? | |
| | Voice | QL_ITR_0002 | Is the voice natural? | |
| | Emotion | QL_ITR_0003 | Does this digital human seem to | |
| | | | display genuine emotions? | |
| | | QL_ITR_0004 | How close to psychologically | |
| | | | comfortable do you feel when | |
| | | | talking with a digital human in a | |
| | | | virtual environment or content? | |
| Cognitive | Understand | QL_CSP_0001 | How much of what the digital | [B1] |
| Social | | | Human was trying to say do you | |
| Presence | | | understand? | |
| | | QL_CSP_0002 | How much of the state of feeling do | [B2] |
| | | | you understand through what the | |
| | | | digital human says? | |
| | Perception | QL_CSP_0003 | How much do you feel like you were | [B2] |
| | | | in the same place as a digital | |
| | | | human? | |
| | | QL_CSP_0004 | How much do you feel you met and | |
| | | | talked to a digital human in person? | |
| Emotional | Immediateness | QL_ESP_0001 | Are you satisfied with the | [B3] |
| Social | | | conversation with a digital human? | |
| Presence | | QL_ESP_0002 | Are you focused on the | [B3] |
| | | | conversation with a digital human? | |
| | Intimacy | QL_ESP_0003 | Do you feel an emotional | [B4] |
| | | | connection with a digital human? | |
| | | QL_ESP_0004 | Do you feel close to a digital | [B4] |
| | | | human? | |

| Whole human | QL_WDH_0001 | As a whole, does this look like a |
|---|---|---|
| | | person? |
| User defined | QL_UDF_xxxx | Questions according to the |

application field of digital human.

Meanwhile, the evaluation method set 140 is a set of evaluation methods for question items in the question list 130 and is a tool for evaluating the digital human content in the source input 110. The evaluation methods include subjective evaluation methods and objective evaluation methods. The subjective evaluation methods are evaluation methods used to evaluate the service according to the source input 110 provided to the testers 170. The subjective evaluation methods include at least one of a checklist method, a ranking method, a paired comparison method, a grading method, or an essay evaluation method.

The checklist method is a technique that uses using a checklist, which is a pre-prepared list of check items of performance or properties to be checked by a tester. Examples of checklists for evaluating the quality of digital human content include a simple checklist and a weighted checklist. The simple checklist uses two response options, “yes” and/or “no” in a survey or questionnaire. The weighted checklist uses response options with weighted values such as 1-5, 0-20-40-60-80-100%. The checklist method is defined based on an identification information field, a checklist type field, a field for the number of response options, a response option field, and an evaluation result field.

The ranking method is a technique used to evaluate the quality of digital human content by determining the order of various options for the evaluation. The ranking method is a traditional but efficient method for evaluation. For example, when the testers determine their preference for options for the eyes, ears, mouth, and hair of a digital human, the ranking method assigns a higher score in the order of preference for the options. The ranking method is defined based on an identification information field, a name field of the ranking option, and a value field of the ranking.

The paired comparison method is a technique used to compare quality factors in pairs to determine whether one quality factor is better than the other in quantitative characteristics or whether the two factors are the same. For example, quality factors H1 and H2 are arranged horizontally, while V1 and V2 are arranged vertically. (H1, V1), (H1, V2), (H2, V1), and (H2, H2) are compared pairwise. H1 may be an eye, and V1 may be an eye gesture. In this case, the evaluation values are assigned in each pair by the tester using the same list of questions. The paired comparison method is defined based on an identification information field, a horizontal name field, a vertical name field, and a comparison value field.

The grading method includes label grading, pass/fail grading, and point grading. The label grading is to assign points according to mapped labels, such as A:95, B:85, C:75, D:65 and F:0. The pass/fail grading is similar to the label grading, but uses only two labels, such as “Pass” and “Fail”. A predetermined score is assigned to each label. For example, “Pass” could be 100 and “Fail” could be 0. The point grading is to directly assign scores between the highest score and the lowest score by the tester. The highest and lowest points are between 0 and 100. The point grading can specify the steps when assigning the scores. The grading method is defined based on an identification information field, a grading type field, a field for the number of response options, a grading label field, a grade-high field and a grade-low field for point grading, a grade step field, a grade point field, and an evaluation result field.

The essay evaluation method is a technique that uses a description of the quality of digital human content written by the tester. This description is an evaluation of the quality of the content based on facts and often includes examples and evidence to support the information. The tester is asked to express the strengths and weaknesses of the quality of digital human content. The testers create a description of the quality based on the characteristics of the digital human and based on the social presence. The essay evaluation method is defined based on an identification information field and an essay field. The essay field includes descriptions written by the testers.

Meanwhile, the objective evaluation methods are used to evaluate the quality of the digital human content of the source input 110 using the external test tool set 150. The objective evaluation methods include either a Fréchet Inception Distance (FID) method or a Structural Similarity Index Map (SSIM) method.

The FID method is a technique that uses the Fréchet Inception Distance (FID) to capture the similarity between two groups of images. FID is a model used to evaluate the performance of AI-generated images. The FID score represents the statistical distribution distance of two sets of images. A smaller FID indicates that the two groups are more similar, and a score of 0 means that the two groups are identical. The FID method is defined based on an identification information field, an evaluation method information field including a Uniform Resource Locator (URL), an actual image set field, an actual image set url field, a test image set url field, and an evaluation result field.

The SSIM method is a technique used to capture the similarity between two images. The SSIM method is not intended to directly compare pixel-level differences, but rather to compare the differences in the human visual system, such as brightness, contrast, structure, etc. The output of the SSIM method ranges from 0 to 1, with 1 indicating excellent quality. The SSIM method is defined based on an identification information field, an evaluation method information field including a URL, a reference real person url field including a description of a real person image, a test digital human url field, and an evaluation result field.

The test method generation unit 161 receives test methods including identification information of questions and evaluation methods for the questions, and referring to a pre-stored question list 130 and an evaluation method set 140, generates at least one of subjective test methods or objective test methods from the test methods;

Specifically, the test method generation unit 161 includes a parser 161a and a selector 161b. The parser 161a receives the test case input 120 and analyzes the syntax in the test case input 120. If the test case input 120 follows the JSON format, the parser 161a analyzes the syntax of the test case input 120 according to the JSON format. According to the syntax analysis, the identification information of the questions and the evaluation methods of the test methods in the test case input 120 are obtained. Then, the selector 161b receives the syntax analysis result, and selects and collects question items corresponding to the identification information of the questions of the test case input 120 from the question list 130. The selector 161b identifies subjective evaluation methods and objective evaluation methods from the evaluation methods in the test case input 120 by referring to the evaluation method set 140. The selector 161b generates at least one of the subjective test methods 163a or the objective test methods 163b by combining the question items with the subjective evaluation methods or the objective evaluation methods. One question item is combined with one subjective evaluation method or one objective evaluation method. Then, the selector 161b provides at least one of the subjective test methods 163a or the objective test methods 163b to the evaluation result acquisition unit 163.

According to an embodiment of the present disclosure, the test method generation unit 161 may select at least one of the test methods in the test case input 120 in view of the characteristics of the digital human in the source input 110. Here, the characteristics of the digital human may include information on the digital human's physical features, such as skin, hair color, iris, eyebrows, facial proportion, hairstyle, body proportion, hand shape, foot shape, etc. Additionally, the characteristics of the digital human may include information indicating the digital human's behavioral characteristics, such as voice characteristics, walking distance, hand movement, arm movement, mouth shape, eye blinks, etc. The characteristics of the digital human may be determined according to Metadata of the source input 110. The test method generation unit 161 may select a part of the test methods based on the characteristics of the digital human and generate the subjective test methods 163a and the objective test methods 163b by combining the question items and the evaluation methods corresponding to the selected part of the test methods.

According to an embodiment of the present disclosure, the test method generation unit 161 may receive a previous evaluation result of the source input 110 from the quality evaluation unit 165 as feedback, and select at least one of the test methods in the test case input 120 based on the previous evaluation result. The test method generation unit 161 may select a part of the test methods in the test case input 120 based on previous evaluation scores of the subjective test methods 163a and the objective test methods 163b and update the subjective test methods 163a and the objective test methods 163b by combining the question items and the evaluation methods corresponding to the selected part of the test methods.

The evaluation result acquisition unit 163 obtains subjective evaluation results for digital human content using the subjective test methods 163a and obtains objective evaluation results for digital human content using the objective test methods 163b.

Specifically, the evaluation result acquisition unit 163 performs the subjective test methods 163a through the testers 170 and performs the objective test methods 163b using the external test tool set 150.

A questionnaire generator 163c in the evaluation result acquisition unit 163 generates a questionnaire based on the question items and the subjective evaluation methods included in the subjective test methods 163a. As an example, the question item in the question list 130 may be “Are the digital human's eyes realistic?”, and the evaluation method may be “Evaluate with an integer value between 1 and 5”. In this case, the generated test method may be “Evaluate the realism of the digital human's eyes on a scale of 1 to 5”. The questionnaire may include n questions and subjective evaluation methods. A query unit 163d provides the generated questionnaires to the testers 170 and receives response results of the questionnaires. The testers 170 are provided with a service based on the digital human in the source input 110 and then evaluate the quality of the digital human in the source input 110 according to the questionnaire. The query unit 163d receives the subjective evaluation results of the testers 170 and provides the subjective evaluation results to the quality evaluation unit 165.

Meanwhile, the evaluation result acquisition unit 163 calculates an evaluation score for each of the objective test methods 163b using the external test tool set 150. The question items and the objective evaluation methods included in the objective test methods 163b are evaluated by the external test tool set 150. The evaluation result acquisition unit 163 provides objective evaluation results to the quality evaluation unit 165.

The quality evaluation unit 165 calculates evaluation scores of the subjective test methods 163a and evaluation scores of the objective test methods 163b based on the subjective evaluation results and the objective evaluation results, and calculates the result data 180 based on the evaluation scores of the subjective test methods 163a and the evaluation scores of the objective test methods 163b. The result data 180 represents a final evaluation result.

Specifically, the quality evaluation unit 165 calculates evaluation scores of the subjective test methods 163a and evaluation scores of objective test methods 163b based on the subjective evaluation results and the objective evaluation results. Here, the evaluation score of each subjective test method may be a weighted average value of evaluation results of the testers 170 for each subjective test method. For example, when the testers 170 select one of the integer values in the range of 1 to 5, the evaluation score may be a weighted average of the integer values, where each integer value is used as a weight based on the number of times it was selected. Furthermore, the quality evaluation unit 165 calculates an evaluation score for each objective test method based on the objective evaluation results.

The quality evaluation unit 165 may normalize the evaluation scores of the subjective test methods 163a and the evaluation scores of the objective test methods 163b to real values between 0 and 1. Accordingly, each normalized evaluation score may have a real value between 0 and 1. If the normalized evaluation score is high, it means that the quality of the digital human content of the source input 110 is high.

As the result data 180, the quality evaluation unit 165 may generate the evaluation scores for the generated test methods 163a and 163b in an array form, respectively. The result data 180 may be array data including both the evaluation scores of the subjective test methods 163a and the normalized evaluation scores of the objective test methods 163b. The service provider may check the quality of the digital human content of the source input 110 for each question item based on the final evaluation score.

As the result data 180, the quality evaluation unit 165 may convert the normalized evaluation scores for the generated test methods 163a and 163b into one final evaluation score. The result data 180 may be a weighted sum or a weighted average of the evaluation scores of the generated test methods 163a and 163b based on the weights of the generated test methods 163a and 163b. The service provider may check the overall quality of the digital human content of the source input 110 based on the final evaluation score.

Furthermore, the quality evaluation unit 165 may determine a quality level of the source input 110 based on the evaluation scores. Here, the quality grade is a value obtained by grading the evaluation scores derived from the evaluation of the quality of the digital human content according to digital human content quality standards for each application.

The result data 180 generated by the quality evaluation unit 165 may include at least one of information (Info) on test conditions, a scalar result (Result_scalar), or a vector result (Result_vector). The information on test conditions may include a general description of the test results. For example, the information on test conditions may include the number of testers 170, a p-value indicating a statistical significance probability for the subjective test methods 163a, etc. The scalar result is a weighted average of normalized evaluation scores and may be a real value between 0 and 1. The vector result is an array of all evaluation scores, and each evaluation score may be normalized to a real value between 0 and 1. When the number of subjective test methods 163a is n and the number of objective test methods 163b is m, the vector result may be a vector of dimension n+m. The above-mentioned components represent semantic key values of the result data 180.

The quality evaluation unit 165 may provide feedback on the final evaluation score to the test method generation unit 161.

Depending on the result data 180, the service provider may provide an appropriate service based on the quality evaluation results of the testers 170 for the source input 110. For example, when the final evaluation score for the digital human content used in a kiosk service is 0.9, the service provider may apply the digital human content to the kiosk service.

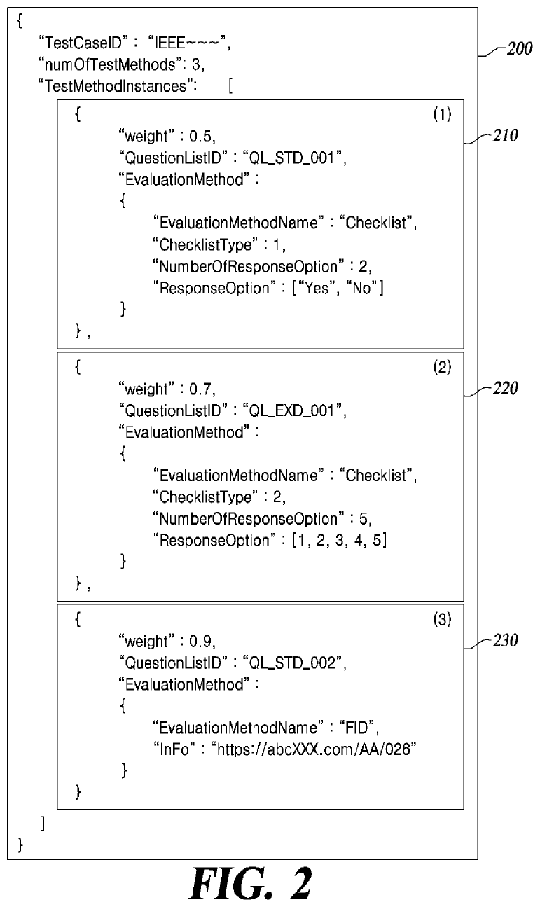

FIG. 2 is a diagram illustrating a test case input according to an embodiment of the present disclosure.

Referring to FIG. 2, a test case input 200, a first test method 210, a second test method 220 and a third test method 230 are shown.

TestCaseID indicating identification information of the test case input 200 is “IEEE˜˜˜˜”, and numOfTestMethods indicating the number of test methods included in the test case input 200 is 3. Weights of the first test method 210, the second test method 220, and the third test method 230 are set to 0.5, 0.7, and 0.9, respectively.

QuestionListID indicating question identification information of the first test method 210 is “QL_STD_001”, and STD may indicate identification information of the questions described in the standard document IEEE 3097.3 or Table 1. EvaluationMethodName indicating evaluation method identification information of the first test method 210 is “Checklist”; and ChecklistType, NumberOfResponseOption, and ResponseOption indicating evaluation method response formats are 1, 2, and [“Yes”, “No”], respectively. The testers are asked to select either “Yes” or “No” for the question item according to QL_STD_001.

QuestionListID indicating question identification information of the second test method 220 is “QK_EXD_001”, and EXD may indicate identification information of questions not described in the standard document IEEE 3097.3 and Table 1. That is, it is a question defined by the user. The testers are asked to select one of five integers consisting of 1 to 5 for the question item according to QL_EXD_001.

The QuestionListID of the third test method 230 is “QK_STD_002”, and the EvaluationMethodName is “FID”. The evaluation method of the third test method 230 is an objective evaluation method. The third test method 230 may further include URL information in which image data for the digital human content of the source input is stored and URL information in which image data for a real person to be compared is stored. The test tool set of the third test method 230 may be referenced by a predetermined link address. Upon accessing the corresponding link, a source code for the test tool set that can be used to evaluate the source input is provided. The quality evaluation device may access the link address to load the source code for the FID and apply the source code to the image data for the digital human in the source input and the image data for the real person, thereby obtaining an evaluation score of the third test method 230 indicating the Fréchet distance between two images. The FID method obtains an objective evaluation result by inputting an input image as a large-scale still image to a model used to calculate the FID.

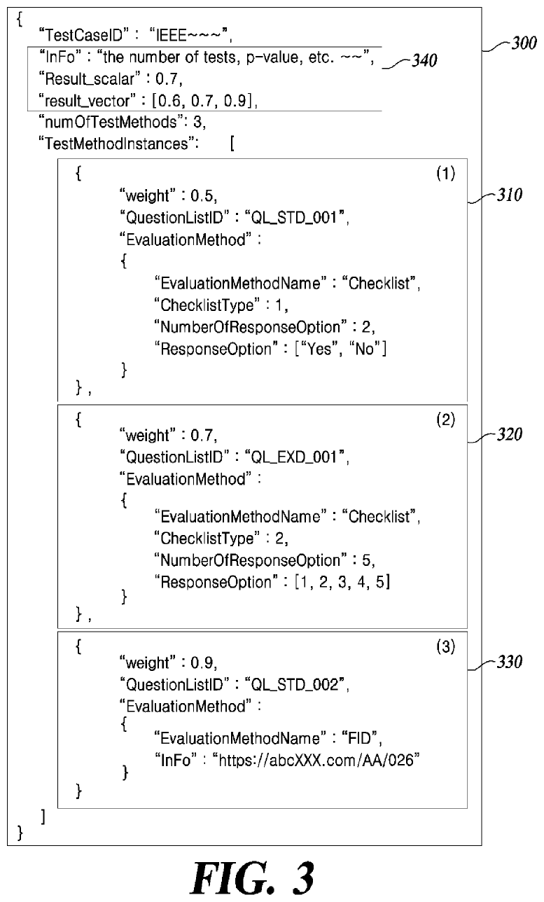

FIG. 3 is a diagram illustrating a test case output according to an embodiment of the present disclosure.

Referring to FIG. 3, a test case output 300, a first test method 310, a second test method 320, a third test method 330, and result data 340 are shown.

The first test method 310, the second test method 320, and the third test method 330 correspond to the first test method 210, the second test method 220, and the third test method 230 shown in FIG. 2, respectively.

The test case output 300 further includes result data 340 in addition to the test case input. “Info” indicating information on test conditions may describe the test conditions. Result_vector in the result data 340 represents normalized evaluation scores for the first test method 310, the second test method 320, and the third test method 330. The normalized evaluation score of the first test method 310 is 0.6, and the normalized evaluation score of the second test method 320 is 0.7. Result_scalar is a weighted average value of normalized evaluation scores for the first test method 310, the second test method 320, and the third test method 330.

The service provider may intuitively check the quality of the digital human of the source input based on the result data 340.

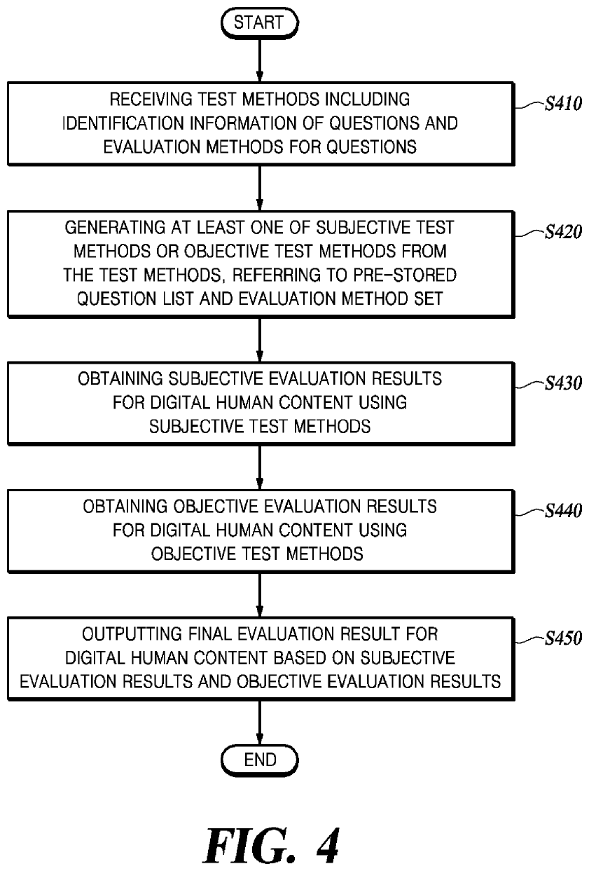

FIG. 4 is a flowchart of a method for evaluating the quality of a digital human according to an embodiment of the present disclosure.

Referring to FIG. 4, first, a source input including digital human content is defined.

The quality evaluation device receives test methods including identification information of questions and evaluation methods for the questions (S410).

The test case input may be created by a test designer. One question in the test case input may be combined with one evaluation method.

Referring to a pre-stored question list and evaluation method set, the quality evaluation device generates at least one of subjective test methods or objective test methods from the test methods (S420).

Specifically, the question list is a set of questions defined by quality factors based on the characteristics of the digital human and based on the social presence. Each question is assigned unique identification information. The quality evaluation device may collect a question item corresponding to the identification information of each question from the question list.

The evaluation method set is a set of evaluation methods for question items in the question list and is a tool for evaluating the digital human content in the source input. The evaluation method set includes identification information of subjective evaluation methods and identification information of objective evaluation methods. The quality evaluation device identifies subjective evaluation methods and objective evaluation methods from the evaluation methods using the evaluation method set. The quality evaluation device may collect a response format or a test tool set of an evaluation method corresponding to the identification information of each evaluation method from the evaluation method set.

Then, the quality evaluation device generates at least one of the subjective test methods or the objective test methods by combining the question items with the subjective evaluation methods or the objective evaluation methods. Each subjective test method includes one question item and one response format of the subjective evaluation method, and each objective test method includes one question item and one response format of the objective evaluation method.

Meanwhile, according to an embodiment of the present disclosure, the quality evaluation device selects a part of the test methods based on the characteristics of the digital human content in the source input. The quality evaluation device may generate at least one of subjective test methods or objective test methods from the selected test methods. For example, if the digital human content is about a human face, the quality evaluation device may select questions about the human face from the received questions. The quality evaluation device may select evaluation methods for the selected questions from the received evaluation methods.

Furthermore, the quality evaluation device may select a part of the test methods based further on a previous final evaluation result for the digital human content.

The quality evaluation device obtains subjective evaluation results for the digital human content using the subjective test methods (S430).

The quality evaluation device generates a questionnaire based on the subjective test methods and receives subjective evaluation results in response to providing the questionnaire to external testers. The subjective evaluation results refer to the results selected by the testers from several options.

The quality evaluation device obtains objective evaluation results for the digital human content using the objective test methods (S440).

The quality evaluation device may obtain the objective evaluation results by applying an external test tool set according to each objective test method to the source input. For example, the quality evaluation device may obtain the objective evaluation results by loading an FID model and applying it to video data of the source input.

The quality evaluation device outputs a final evaluation result for the digital human content based on the subjective evaluation results and the objective evaluation results (S450).

Specifically, the quality evaluation device calculates subjective evaluation scores for the subjective test methods and objective evaluation scores for the objective test methods based on the subjective evaluation results and the objective evaluation results. The quality evaluation device normalizes the subjective evaluation scores and the objective evaluation scores. The quality evaluation device may output the final evaluation result including the normalized subjective evaluation scores and the normalized objective evaluation scores. In this case, the final evaluation result may include the normalized subjective evaluation scores and the normalized objective evaluation scores in an array form.

Furthermore, the quality evaluation device calculates an average of weighted scores by applying predetermined weights for each of the subjective test methods and the objective test methods to the normalized subjective evaluation scores and the normalized objective evaluation scores. The quality evaluation device may output the final evaluation result including the calculated average value. The final evaluation result may include the normalized evaluation scores in an array form and one final evaluation score. The final evaluation result may include the subjective evaluation scores and the objective evaluation scores calculated based on the subjective evaluation results and the objective evaluation results, and may further include identification information of questions and identification information of evaluation methods for the questions. The service provider may intuitively check the quality of digital human content based on the final evaluation result.

According to an embodiment of the present disclosure, the quality of a digital human can be objectively evaluated through systematization of a quality evaluation method consisting of a combination of a question list and an evaluation method.

The effects of the present disclosure are not limited to those mentioned above, and other effects not mentioned will be clearly understood by those skilled in the art from the description above.

At least some of the components described in the exemplary embodiments of the present disclosure may be implemented as hardware elements including at least one of a Digital Signal Processor (DSP), a processor, a controller, an Application-Specific IC (ASIC), a programmable logic devices (FPGA, etc.), other electronic components, or a combination thereof. Moreover, at least some of the functions or processes described in the exemplary embodiments may be implemented as software, and the software may be stored in a recording medium. At least some of the components, functions, and processes described in the exemplary embodiments of the present disclosure may be implemented as a combination of hardware and software.

The method according to the exemplary embodiments of the present disclosure may be written as a program that can be executed on a computer and may also be implemented as various recording media such as magnetic storage media, optical reading media, digital storage media, etc.

Various techniques described herein may be implemented in digital electronic circuitry, or in computer hardware, firmware, software, or combinations thereof. Implementations may be in the form of a computer program tangibly embodied in a computer program product, i.e., an information carrier, e.g., a machine-readable storage device (computer-readable medium) or a propagated signal, for processing by, or controlling, the operation of, a data processing device, e.g., a programmable processor, a computer, or a number of computers. A computer program, such as the above-mentioned computer program(s), may be written in any form of programming language, including compiled or interpreted languages and may be deployed in any form, including as a stand-alone program or as a module, component, subroutine, or other unit suitable for use in a computing environment. The computer program may be deployed to run on a single computer or multiple computers at one site or distributed across multiple sites and interconnected by a communications network.

In addition, components of the present disclosure may use an integrated circuit structure such as a memory, a processor, a logic circuit, a look-up table, and the like. These integrated circuit structures execute each of the functions described herein through the control of one or more microprocessors or other control devices. In addition, components of the present disclosure may be specifically implemented by a program or a portion of a code that includes one or more executable instructions for performing a specific logical function and is executed by one or more microprocessors or other control devices. In addition, components of the present disclosure may include or be implemented as a Central Processing Unit (CPU), a microprocessor, etc. that perform respective functions. In addition, components of the present disclosure may store instructions executed by one or more processors in one or more memories.

Processors suitable for processing computer programs include, by way of example, both general purpose and special purpose microprocessors, as well as one or more processors of any kind of digital computer. Generally, a processor will receive instructions and data from a read-only memory or a random access memory or both. The essential elements of a computer may include at least one processor that executes instructions and one or more memory devices that store instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include, by way of example, semiconductor memory devices, e.g., Magnetic Media such as hard disks, floppy disks, and magnetic tapes, Optical Media such as Compact Disk Read Only Memories (CD-ROMs) and Digital Video Disks (DVDs), Magneto-Optical Medial such as Floptical Disks, Rea Only Memories (ROMs), Random Access Memories (RAMs), flash memories, Erasable Programmable ROMs (EPROMs), Electrically Erasable Programmable ROMs (EEPROM), etc. The processor and the memory may be supplemented by, or incorporated in, special purpose logic circuitry.

The processor may execute an Operating System and software applications executed on the Operating System. Moreover, a processor device may access, store, manipulate, process, and generate data in response to software execution. For the sake of convenience, there is a case where a single processor device is used, but those skilled in the art will understand that the processor device can include multiple processing elements and/or multiple types of processing elements. For example, the processor device may include a plurality of processors or a single processor and a single controller. Other processing configurations, such as such as parallel processors, are also possible.

In addition, non-transitory computer-readable media may be any available media that can be accessed by a computer, and may include both computer storage media and transmission media.

This specification includes details of various specific implementations, but they should not be understood as limiting the scope of any invention or what is claimed, and should be understood as descriptions of features that may be unique to particular embodiments of a particular invention. In the context of individual embodiments, specific features described herein may also be implemented in combination with a single embodiment. On the contrary, various features described in the context of a single embodiment can also be implemented in multiple embodiments independently or in any appropriate sub-combination. Further, although the features may operate in a particular combination and may be initially described as so claimed, one or more features from the claimed combination may be in some cases excluded from the combination, and the claimed combination may be modified into a sub-combination or a variation of the sub-combination.

Likewise, although the operations are depicted in the drawings in a particular order, it should not be understood that such operations must be performed in that particular order or sequential order shown to achieve the desirable result or that all the depicted operations should be performed. In certain cases, multitasking and parallel processing may be advantageous. Moreover, the separation of various device components of the above-described embodiments should not be understood as requiring such separation in all embodiments, and it should be understood that the described program components and devices can generally be integrated together in a single software product or packaged into multiple software products.

The foregoing description is merely illustrative of the technical concept of the present embodiments. Various modifications and changes may be made by those of ordinary skill in the art without departing from the essential characteristics of each embodiment. Therefore, the present embodiments are not intended to limit but to describe the technical idea of the present embodiments. The scope of the technical concept of the embodiments is not limited by these embodiments. The scope of protection of the various embodiments should be construed by the following claims. All technical ideas that fall within the scope of equivalents thereof should be interpreted as being included in the scope of the present embodiments.

What is claimed is:

1. An apparatus for evaluating the quality of digital human content included in a source input, the apparatus comprising:
a test method generation unit configured to receive test methods including identification information of questions and evaluation methods for the questions, and referring to a pre-stored question list and an evaluation method set, generate at least one of subjective test methods or objective test methods from the test methods;
an evaluation result acquisition unit configured to obtain subjective evaluation results for the digital human content using the subjective test methods and obtain objective evaluation results for the digital human content using the objective test methods; and
a quality evaluation unit configured to output a final evaluation result for the digital human content based on the subjective evaluation results and the objective evaluation results.

2. The apparatus of claim 1, wherein the test method generation unit is configured to collect question items corresponding to the identification information of the questions from the question list, identify subjective evaluation methods and objective evaluation methods from the evaluation methods using the evaluation method set, and generate at least one of the subjective test methods or the objective test methods by combining the question items with the subjective evaluation methods or the objective evaluation methods.

3. The apparatus of claim 1, wherein the evaluation method set comprises identification information of subjective evaluation methods and identification information of objective evaluation methods.

4. The apparatus of claim 1, wherein the test method generation unit is configured to select a part of the test methods based on the characteristics of the digital human content in the source input and generate at least one of the subjective test methods or the objective test methods from the selected test methods.

5. The apparatus of claim 4, wherein the test method generation unit is configured to select the part of the test methods based further on a previous final evaluation result for the digital human content.

6. The apparatus of claim 1, wherein the evaluation result acquisition unit is configured to generate a questionnaire based on the subjective test methods and receive the subjective evaluation results in response to providing the questionnaire to external testers.

7. The apparatus of claim 1, wherein the quality evaluation unit is configured to obtain the objective evaluation results by applying an external test tool set according to each objective test method to the source input.

8. The apparatus of claim 1, wherein the quality evaluation unit is configured to calculate subjective evaluation scores for the subjective test methods and objective evaluation scores for the objective test methods based on the subjective evaluation results and the objective evaluation results, normalize the subjective evaluation scores and the objective evaluation scores, and output the final evaluation result including the normalized subjective evaluation scores and the normalized objective evaluation scores.

9. The apparatus of claim 8, wherein the quality evaluation unit is configured to output the final evaluation result including an average of weighted scores calculated by applying predetermined weights for each of the subjective test methods and the objective test methods to the normalized subjective evaluation scores and the normalized objective evaluation scores.

10. The apparatus of claim 1, wherein the final evaluation result comprises subjective evaluation scores and objective evaluation scores calculated based on the subjective evaluation results and the objective evaluation results, and further comprises identification information of the questions and identification information of the evaluation methods for the questions.

11. A computer-implemented method for evaluating the quality of digital human content included in a source input, the method comprising:
receiving test methods including identification information of questions and evaluation methods for the questions;
referring to a pre-stored question list and an evaluation method set, generating at least one of subjective test methods or objective test methods from the test methods;
obtaining subjective evaluation results for the digital human content using the subjective test methods;
obtaining objective evaluation results for the digital human content using the objective test methods; and
outputting a final evaluation result for the digital human content based on the subjective evaluation results and the objective evaluation results.

12. The method of claim 11, wherein the generating comprises:
collecting question items corresponding to the identification information of the questions from the question list;
identifying subjective evaluation methods and objective evaluation methods from the evaluation methods using the evaluation method set; and
generating at least one of the subjective test methods or the objective test methods by combining the question items with the subjective evaluation methods or the objective evaluation methods.

13. The method of claim 11, wherein the evaluation method set comprises identification information of subjective evaluation methods and identification information of objective evaluation methods.

14. The method of claim 11, wherein the generating comprises:
selecting a part of the test methods based on the characteristics of the digital human content in the source input; and
generating at least one of the subjective test methods or the objective test methods from the selected test methods.

15. The method of claim 14, wherein the selecting comprises selecting the part of the test methods based further on a previous final evaluation result for the digital human content.

16. The method of claim 11, wherein the obtaining the subjective evaluation results comprises:
generating a questionnaire based on the subjective test methods; and
receiving the subjective evaluation results in response to providing the questionnaire to external testers.

17. The method of claim 11, wherein the obtaining the objective evaluation results comprises obtaining the objective evaluation results by applying an external test tool set according to each objective test method to the source input.

18. The method of claim 11, wherein the outputting comprises:
calculating subjective evaluation scores for the subjective test methods and objective evaluation scores for the objective test methods based on the subjective evaluation results and the objective evaluation results;
normalizing the subjective evaluation scores and the objective evaluation scores; and
outputting the final evaluation result including the normalized subjective evaluation scores and the normalized objective evaluation scores.

19. The method of claim 18, wherein the outputting the final evaluation result comprises outputting the final evaluation result including an average of weighted scores calculated by applying predetermined weights for each of the subjective test methods and the objective test methods to the normalized subjective evaluation scores and the normalized objective evaluation scores.

20. The method of claim 11, wherein the final evaluation result comprises subjective evaluation scores and objective evaluation scores calculated based on the subjective evaluation results and the objective evaluation results, and further comprises identification information of the questions and identification information of the evaluation methods for the questions.
